(19) United States
(12) Patent Application Publication
(10) Pub. No.: US 2024/0143048 A1
(43) Pub. Date: May 2, 2024

(54) SLOTTED STORAGE SYSTEM

(71) Applicant: Techtronic Cordless GP, Anderson, SC (US)

(72) Inventors: Jeffrey Groves, Greenville, SC (US); Connor Irwin, LaFayette, LA (US); William Michael Felton, Colchester, VT (US); Charles M. Wacker, II, Anderson, SC (US); Sage Van Wyk, Greenville, SC (US); JohnDerek Parsons, Greenville, SC (US)

(21) Appl. No.: 18/495,157

(22) Filed: Oct. 26, 2023

Related U.S. Application Data
(60) Provisional application No. 63/419,795, filed on Oct. 27, 2022.

(51) Int. Cl. G06F 1/18

(52) U.S. Cl. CPC G06F 1/187

(57) ABSTRACT

A multi-component storage system is provided. The storage system includes a primary storage component and a secondary storage component. The primary storage component includes a body surrounding a storage area, the body having a plurality of support ribs extending therefrom, the plurality of support ribs including at least one pair of support ribs on opposing sides of the body. The primary storage component includes at least one open side. The secondary storage component is configured to be inserted within the storage area of the primary storage component through the at least one open side and aligned with the at least one pair of support ribs.

### CROSS-REFERENCE TO RELATED APPLICATIONS

The present application claims priority to U.S. Provisional Patent Application Ser. No. 63/419,795 filed on Oct. 27, 2022, the disclosure of which is incorporated by reference herein in its entirety.

### FIELD

The present disclosure relates generally to storage systems, and more particular to modular multi-component storage systems for tools and the like.

### BACKGROUND

Hand tools, power tools, and associated accessories such as batteries, tool bits, fasteners, and the like, may be moved frequently between a storage space and a workspace. One aspect of accessibility is a user's ability to quickly store an object and remove the object from storage. Another aspect of accessibility is the storage system's ability to engage many objects with a standardized connection mechanism between the system and the object. This may also permit an object to engage the storage system at a plurality of locations. Storage systems may also be accessible for extension or expansion.

A common user workflow for handling of hand tools, power tools, and associated accessories for a project includes three phases: (1) static organization of the tools and accessories in a workshop; (2) organization for transit; and (3) organization for “job site”. While tools and accessories may be thoughtfully organized in a static organization system in a workshop, they must be condensed down to a mobile volume for transit. However, existing storage systems for organization of tools and accessories for transit to a job site leave much to be desired. For instance, open volume and bag storage systems commonly used for transit can be chaotic and disorganized without intentional storage zones to hold each item in place. After transit to a “job site,” the tools and accessory organization may be expanded back out to create a usable work space. However, due to poor or non-existent organizational solutions during transit, organization at a job site may be difficult as well. Moreover, mobile organizational solutions for setting up a job site in a functional and usable work space may be insufficient to both provide easy functional access to tools and accessories while maintaining organization.

Accordingly, improved storage systems are desired in the art. In particular, storage systems which provide an interface on internal and/or external surfaces of storage containers to be secured together for both static storage and transportable storage would be advantageous.

### BRIEF DESCRIPTION

Aspects and advantages of the invention in accordance with the present disclosure will be set forth in part in the following description, or may be obvious from the description, or may be learned through practice of the technology.

In accordance with one embodiment, a storage system is provided. The storage system includes a primary storage component and a secondary storage component. The primary storage component includes a body surrounding a storage area, the body having a plurality of support ribs extending therefrom, the plurality of support ribs including at least one pair of support ribs on opposing sides of the body. The primary storage component includes at least one open side. The secondary storage component is configured to be inserted within the storage area of the primary storage component through the at least one open side and aligned with the at least one pair of support ribs.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 is a perspective view of a storage system in accordance with embodiments of the present disclosure;

FIG. 2 is a perspective view of a storage system in accordance with embodiments of the present disclosure;

FIG. 3 is a perspective view of a storage system in accordance with embodiments of the present disclosure;

FIG. 4 is a perspective view of a storage system in accordance with embodiments of the present disclosure;

FIG. 5 is a perspective view of a storage system in accordance with embodiments of the present disclosure;

FIG. 6 is a perspective view of a storage system in accordance with embodiments of the present disclosure;

FIG. 7 is a perspective view of a storage system in accordance with embodiments of the present disclosure;

FIG. 8 is a perspective view of a storage system in accordance with embodiments of the present disclosure;

FIG. 9 is a perspective view of a storage system in accordance with embodiments of the present disclosure;

FIG. 10 is a perspective view of a primary storage component in accordance with embodiments of the present disclosure;

FIG. 11 is a rear view of a primary storage component in accordance with embodiments of the present disclosure;

FIGS. 12A-12B are perspective cutaway views of a primary storage component in a locked and unlocked configuration, respectively, in accordance with embodiments of the present disclosure;

FIG. 13 is a partial perspective view a primary storage component in accordance with embodiments of the present disclosure;

FIGS. 14A-I illustrate perspective views of various secondary storage components of a storage system in accordance with embodiments of the present disclosure;

FIG. 15 is a perspective view of a storage system in accordance with embodiments of the present disclosure;

FIG. 16 is a perspective view of a storage system in accordance with embodiments of the present disclosure;

FIG. 17 is a perspective view of a storage system in accordance with embodiments of the present disclosure;

FIG. 18 is a perspective view of a storage system in accordance with embodiments of the present disclosure;

FIG. 19 is a perspective view of a storage system in accordance with embodiments of the present disclosure;

FIG. 20 is a perspective view of a storage system in accordance with embodiments of the present disclosure

FIG. 21 is a perspective view of a storage system in accordance with embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used. herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive—or and not to an exclusive- or. For example, a condition A or Bis satisfied by any one of the following: A is true (or present) and B is false (or not present), A is fake (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

When used to describe a shape, the term “generally” is used to describe an object having the overall appearance of a shape and may include slight deviations from the exact shape, such as including one or more protrusions or indentations in the outline of the shape. For example, the term “generally rectangular” may be used to describe an object having the overall appearance of a rectangle having two sets of parallel sides and four right angles, but may include one or more indentations and/or protrusions along the parallel sides and/or slight variations in the right angles at the corners. For instance, a rectangular shape having slightly rounded corners may be described as “generally rectangular” as used herein. As a further example, a “generally rhomboid” or “generally diamond” shape may have the characteristics of a rhomboid or diamond (a quadrilateral of which only the opposite sides and angles are equal) but may have additional minor (e.g., shorter) sides interposed between the equal opposite angles and sides.

Unless specified or limited otherwise, the terms “mounted,” “connected,” “supported,” and “coupled” and variations thereof are used broadly and encompass both direct and indirect mountings, connections, supports, and couplings. Additionally, unless specified or limited otherwise, the terms “lower,” “upper,” and variations thereof are used broadly for the purposes of describing relative positions of elements of the illustrated embodiments.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is directed to improved multi-component storage systems, e.g., slotted storage systems. Storage systems of the present invention include a primary storage component (e.g., container, toolbox, cabinet, or the like) having a plurality of rails and slots therein, and at least one secondary storage component (e.g., accessory case, tool case, small parts organizer, and others described throughout this disclosure) having an insertion element complementary to the rails and slots of the primary storage component. The primary storage component may include at least one mounting interface or coupling interface to enable stacking, mounting to a storage rail, work table, or the like. The present inventors have found that the multi-component storage system of the present invention facilitates convenient storage and organization of materials between a static organization system, e.g., a garage, and a job site, including during transit to and from a job site.

A slotted storage system may include at least one primary storage component (e.g., container, toolbox, and/or the like) configured to receive and/or be coupled to a secondary storage component and secured relative to one another. The primary storage component may include at least two sides, e.g., forming a V-shaped, U-shaped, rectangular, rectangular prism, or any other suitable shaped storage component. In some embodiments, the primary storage component may include at least three sides, at least four sides, at least five sides, or the like. In some aspects of the disclosure, the primary storage component may include four sides in a generally open rectangular arrangement. In further aspects of the disclosure, the primary storage component may contain five to six sides in a generally rectangular prism arrangement to form, e.g., a container. For example, a sixth side may be removably coupled to form a lid or top of the storage container to optionally enclose a volume of the primary storage component.

The primary storage component includes at least one slotted receiving system. The slotted receiving system may include a pair of ribs protruding from an internal or external surface of at least one side of the primary storage component. The pair of ribs may extend parallel to each other. For instance, the pair of ribs may include a first parallel rib protruding from an internal surface of a first side of the primary storage component and a second parallel rib protruding from an internal surface of a second side of the primary storage component. The first and second sides of the primary storage component may be parallel in a first (e.g., vertical) plane and the first and second parallel ribs may be parallel to each other in a second (e.g., horizontal) plane. In this arrangement, the secondary storage component can extend between the first side and the second side of the primary storage component and be supported by the pair of parallel ribs.

The pair of parallel ribs may include a retaining feature configured to receive a complementary insertion component of a secondary storage component. For instance, the pair of parallel ribs may each include a receiving surface extending downward from a parallel upper surface of each parallel rib. A complementary wing or protrusion of the secondary storage component may have a complementary shape to the receiving surface and can be inserted into or onto the receiving surface to be supported by the parallel ribs. The complementary wing or protrusion may be in the form of a rim or lip around at least a portion of a lid or outer surface of the secondary storage component.

Additionally, the pair of parallel ribs may include a locking feature configured to secure the secondary storage component relative to the primary storage component. For instance, the locking feature may include a slot extending downward from a top surface of each of the parallel ribs. Where the parallel ribs may extend in a longitudinal direction, the slot may have a longest dimension extending in a direction at an angle to the longitudinal direction (e.g., generally perpendicular to the longitudinal direction). Additionally or alternatively, the slot may form a receiving opening for a complementary locking protrusion on the secondary storage component such that the secondary storage component can slide onto the pair of parallel ribs and then the locking protrusion is inserted, e.g., by sliding or any other suitable insertion mechanism, into the receiving opening such that the secondary storage component is secured into place relative to the pair of parallel ribs.

Additionally or alternatively, the locking feature may employ one or more locking plates configured to be locked and unlocked by depressing a latch. For instance, a locking plate may extend along one or more of the parallel ribs. The locking plate may be retracted to an unlocked position by depressing a latch in communication with the locking plate. The secondary storage component may include a complementary receiving opening, e.g., formed as part of the complementary wing or protrusion described above, configured to receive the locking plate when the secondary storage component is supported by the pair of parallel ribs. When the latch is released, the locking plate may be received by the complementary receiving opening of the secondary storage component and secure or lock the secondary storage component in place. Then, when the latch is depressed, the locking plate is retracted into an unlocked position and the secondary storage component can be moved relative to the pair of parallel ribs.

In addition to the slotted receiving system, the primary storage component may include one or more means for coupling the primary storage component to a storage mount system. For instance, the The drawings and accompanying descriptions illustrate slotted storage systems in accordance with various embodiments of the present disclosure.

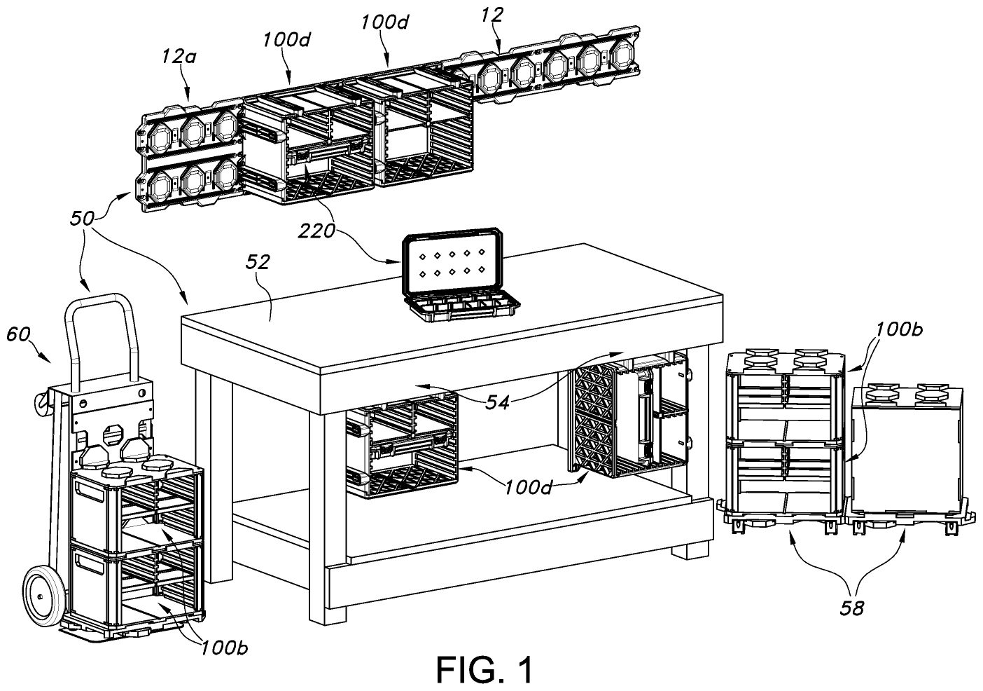

FIG. 1 illustrates a multi-component, multi-level storage and organization system including a slotted storage system 10 that includes several embodiments 100a, 100b and 100c of a primary storage component 100 in accordance with the present invention. Each primary storage component 100 has a body 102 surrounding a storage area 104. The body 102 may have at least one open side 110 configured to enable insertion of one or more secondary storage components 200 within the storage area 104. FIG. 1 illustrates secondary storage components 200 in the form of small part organizers 220 inserted within one or more primary storage components 100e, 170. Additionally, FIG. 1 illustrates various examples of support surfaces 50 to which a primary storage component 100 may be coupled, locked, or mounted to. For instance, a support rail, e.g., a wall rail, 12 or 12a may be mounted to a wall or other vertical surface and a primary storage component may be coupled thereto. A workbench 52 may include one or more workbench mounts 54 configured to receive a primary storage component 100e, as will be described in further detail below. A mobile support, e.g., a dolly 58, hand truck 60, rolling toolbox 62, or other wheeled mobile transport support, may further be configured to receive a primary storage component 100. However, it is to be understood that additional support surfaces 50 not illustrated in FIG. 1 are contemplated by the present invention. The mobile support(s) may include an interface for receiving one or more stacked primary storage components 100. Each primary storage component 100 may include at least one feature for mating the primary storage component 100 to an adjacent primary storage component 100 and/or a support surface 50. Some exemplary mating features for the primary storage components 100 and support surfaces 50 are disclosed in U.S. patent application Ser. No. 17/153,251, filed Jan. 20, 2021. The entire contents of these applications are incorporated by reference herein.

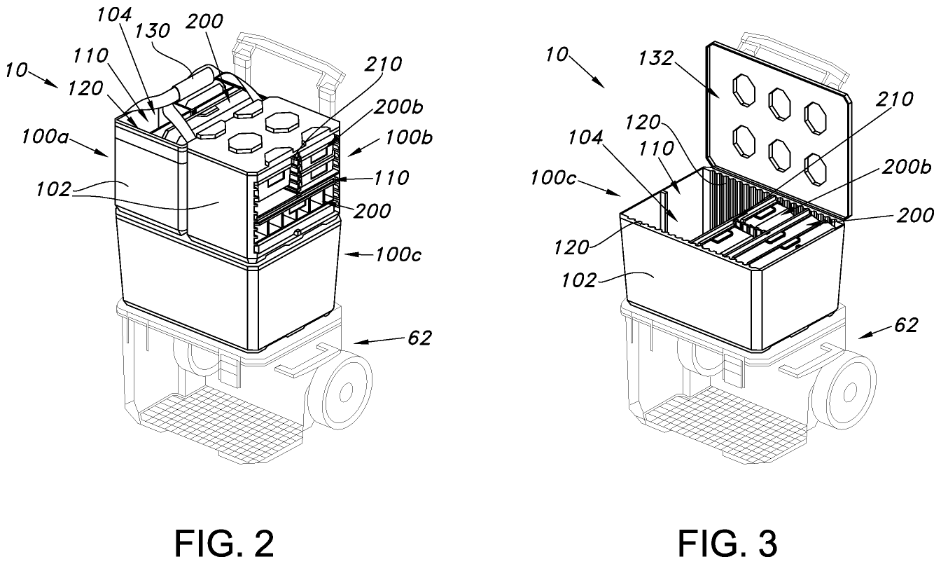

FIG. 2 illustrates a slotted storage system 10 that includes several embodiments 100a, 100b and 100c of a primary storage component 100 in accordance with the present invention. Examples of primary storage components 100 may include, but are not limited to, a toolbox, a shelf (e.g., a wall-mounted shelf), a cabinet, a storage tote, a tote bag, and a crate. Each primary storage component 100 has a body 102 surrounding a storage area 104. The body 102 may have at least one open side 110 configured to enable insertion of one or more secondary storage components 200 within the storage area 104. The body 102 has first and second opposing sides 112, 114. In some aspects of the invention, the first and second opposing sides 112, 114 may extend generally parallel to one another; however, it is not required for the opposing sides to be parallel. Each of the opposing sides 112, 114 include at least one support rib 120. The support ribs 120 may extend generally parallel to each other. The support ribs 120 are illustrated in detail in FIG. 5.

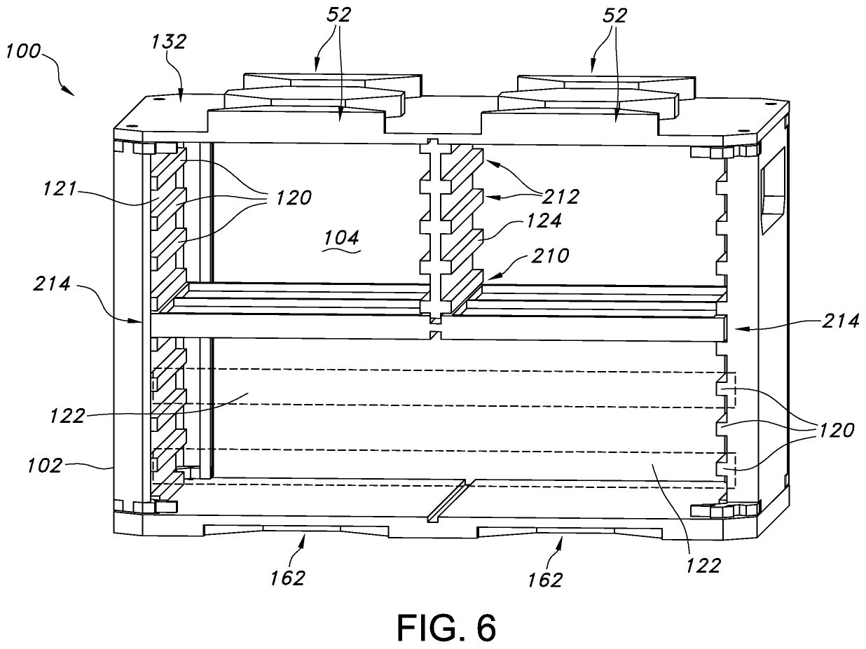

For instance, as illustrated in FIGS. 2-3, each of the opposing sides 112, 114 may include a plurality of support ribs 120. As shown in FIGS. 2-3, the support ribs can extend along a first direction in a generally parallel manner such that a secondary storage component 200 can be supported by the parallel support ribs 120. A pair 122 of support ribs 120 may extend generally parallel to each other in the first direction. (See FIG. 6 for more detail.) The pair 122 may be coplanar in a first plane. The first plane may be generally perpendicular to a second plane formed by the open side 110 of the first storage component 100. In this arrangement, a secondary storage component 200 may be inserted into the storage area 104 through the open side 110 and aligned with a pair 122 of support ribs 120 such that the secondary storage component 200 can be supported by the pair 122 of support ribs 120 within the storage area 104.

As shown in FIG. 2, the primary storage component 100a may have an open side 110. The primary storage component 100a may be enclosed on each of its other sides, e.g., the other five sides of a generally rectangular prism shaped storage container 100a as depicted in FIG. 2. The open side 110 of the primary storage component 100a may be intended to be a top side, as shown in FIG. 2. In one embodiment, the primary storage component 100a may be in the form of a storage tote having one or more handles 130 along opposing edges of the open side 110, such as a soft-sided material or hard-sided material storage tote. The support ribs 120 may extend in a generally vertical orientation when the primary storage component 100a is oriented with the open side 110 at the top side, as shown in FIG. 2.

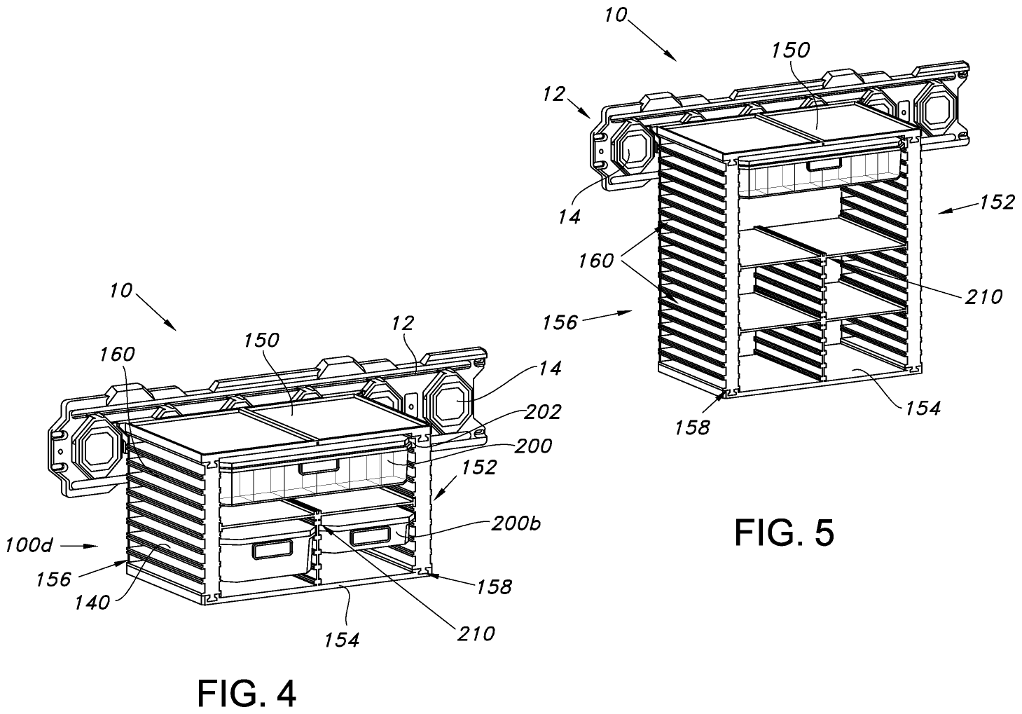

Still shown in FIG. 2, the primary storage component 100b similarly may include at least one open side 110; however, the primary storage component 100b may be generally oriented in a horizontal direction in comparison to the generally vertical orientation of 100a. An open side 110 of the primary storage component 100b may be oriented in a generally vertical plane or direction, and the support ribs 120 may be oriented in a generally horizontal direction such that secondary storage components 200 may be inserted from a side opening and maintain a horizontal orientation. The primary storage component 100b may have one open side 110, as is visible in FIG. 2, or more than one open side 110 such as two opposing open sides 110, as is visible in best in FIGS. 3 and 4.

FIGS. 2 and 3 illustrate a primary storage component 100c, e.g., a storage box or storage tote, in both a closed (FIG. 2) and open (FIG. 3) configuration. The primary storage component 100c may have an open side 110 that is configured to be enclosed by a removable lid 132. In the open configuration (FIG. 3), the removable lid 132 may be coupled to the body 102 along a side, e.g., by hinges, or may be fully removed from the body 102. When the lid 132 is removed from the open side 110 and/or opened to expose the open side 110 and the storage area 104, one or more secondary storage components 200 can be inserted into the storage area 104. In FIG. 3, the open side 110 is configured to be on the top of the primary storage component 100c in a similar manner to the open-top storage tote 100a. The support ribs 120 may extend in a generally vertical orientation, e.g., generally perpendicular to a horizontal plane of the open side 110 and the lid 132 when in the closed configuration.

In some aspects of the present invention, one or more sides of a primary storage component 100d may include support ribs 120a protruding from an external surface 140 of one or more sides, e.g., as illustrated in FIGS. 4 and 5. In a slotted storage system 10 of the present invention, two of the primary storage components 100d may be placed near or adjacent to each other such that one or more secondary storage components 200 may be supported between the external surfaces 140. Thus, the storage capacity in a slotted storage system 10 can be increased beyond the storage area 104 within an individual primary storage component 100. Moreover, support ribs 120 may extend from one or more sides of a primary storage component to mount the primary storage component to an element of a storage mount.

As illustrated in FIGS. 4 and 5, a primary storage component 100d may be formed from four modular sides 150, 152, 154, 156 arranged in a generally rectangular configuration. Two of the sides, e.g., 150 and 154, may have generally common or standardized dimensions and can form, e.g., a top and bottom of the primary storage component 100d, as shown in FIG. 4 and FIG. 5. The other two of the sides, e.g., 152 and 156, may optionally be adjusted to be shorted or longer depending on a user's desired size of the storage area 104 of the primary storage component 100d. For example, the sides 152 and 156 in FIG. 5 are longer or taller than those of FIG. 4. Each of the sides 150, 152, 154, 156 can include one or more locking features 158 configured to secure the sides in place. To form an elongated side such as that shown in FIG. 5, the sides 152 and 156 can be formed from one or more couplable panels 160. For instance, the sides152 and 156 shown in FIG. 4 each have a single panel 160, whereas the elongated sides 152 and 156 shown in FIG. 5 may be formed from two panels 160 coupled together.

Further, as illustrated in FIGS. 4 and 5, one or more brackets 162 can be coupled to a primary storage component 100. The brackets 162 may be coupled to a storage rail 12, for instance, to a mount interface of a storage rail 12 as described in further detail below. For instance, each bracket 162 can have a complementary shape to be received between a pair of adjacent protrusions 14 or cleats as shown in FIGS. 4 and 5. The protrusions 14 can be provided as part of any suitable storage system, e.g., the wall rail 12 configured to be mounted to a vertical surface. Additionally or alternatively, one or more sides of a primary storage component 100 may include a plurality of protrusions 14, as shown in FIG. 2 and FIG. 3. In particular, FIG. 2 illustrates a top surface of the primary storage component 100b and FIG. 3 illustrates the lid 132 each having a plurality of protrusions 14 protruding from an upper surface thereof. As will be described in further detail below, the protrusion 14 on one or more sides of a primary storage component 100 may match the protrusions 14 of the wall rail 12 to form a system having universal coupling capability within the system. Moreover (although not illustrated in FIG. 2), the bottom surfaces of the primary storage components 100a, 100b of FIG. 2 may include recesses 164 or brackets configured to be received and secured relative to the protrusions 14 on the lid 132 of 100c.

Turning now to FIG. 6, the support ribs 120 and 212 and an example divider 210 are illustrated in greater detail. Several pairs 122 of parallel support ribs 120 are denoted by dashed lines. The support ribs 120 may extend from the body 102 of the primary storage component 100 in a direction of the storage area 104. Between each adjacent support rib 120, a channel 121 may be formed. The channel 121 may be generally parallel to the adjacent support rib(s) 120 and may be configured to receive an insertion flange 202 (see, e.g., FIG. 4) of a secondary storage component 200.

While not shown explicitly, the support ribs 120 and 212 may include one or more locking features as described previously in order to secure a secondary storage component 200 relative to the respective support ribs 120, 212. For instance, the one or more locking features may include but are not limited to a slot 124 provided in or along a support rib 120, 212. In some embodiments of the present invention, the slot 124 may receive a protrusion extending from a secondary storage component 200. Although the slot 124 is illustrated in FIG. 5 as extending parallel to a longitudinal direction of the support rib 212, a slot may be provided in or on any surface of one of the support ribs 212, e.g., extending along a top and/or surface of the support ribs 120, 212, and/or extending cross-wise in a direction generally perpendicular to the longitudinal direction. Additionally or alternatively, a plurality of slots 124 may be provided in, on or adjacent to an individual support rib 120, 212. Moreover, any suitable locking feature configured to secure a secondary storage component 200 relative to the respective support ribs 120, 212 may be provided in addition to or instead of a slot 124, as described previously.

Optionally, one or more dividers 210 can be inserted within the storage area 104 of the primary storage component 100, e.g., as shown in FIGS. 1-6, to divide the storage area 104 into smaller compartments. The dividers 210 may be configured to engage with the support ribs 120 to be held in place within the storage area 104. Moreover, the dividers 210 can be provided with divider support ribs 212 on an inner surface or outer surface thereof configured to enable one or more secondary storage components 200 to be supported between a support rib 120 of the primary storage component and a support rib 212 of the divider 210. In this manner, secondary storage components 200b having smaller side-to-side dimensions than a primary storage component 100 (e.g., shown in FIGS. 2 and 3) may be inserted and supported within the slotted storage system 10. One or more dividers 210 may divide the storage area 104 in a first direction, e.g. generally horizontal, and/or a second direction, e.g., generally vertical. For instance, the first direction and second direction may be generally perpendicular.

Additionally illustrated in FIG. 6 is an insertion component 214 of the divider 210. The insertion component 214 is formed to be supported by one of the support ribs 120. For instance, the insertion component 214 may be configured to extend between an upper surface of a supporting support rib 120 and a lower surface of the next adjacent support rib 120 above. While not illustrated, the secondary storage components 200 may each include “wings” or insertion components as described above in a similar manner as shown for the insertion component 214 of the divider 210. Additionally, while not illustrated, each insertion component 214 may include one or more locking features configured to be secured in place relative to the support ribs 120.

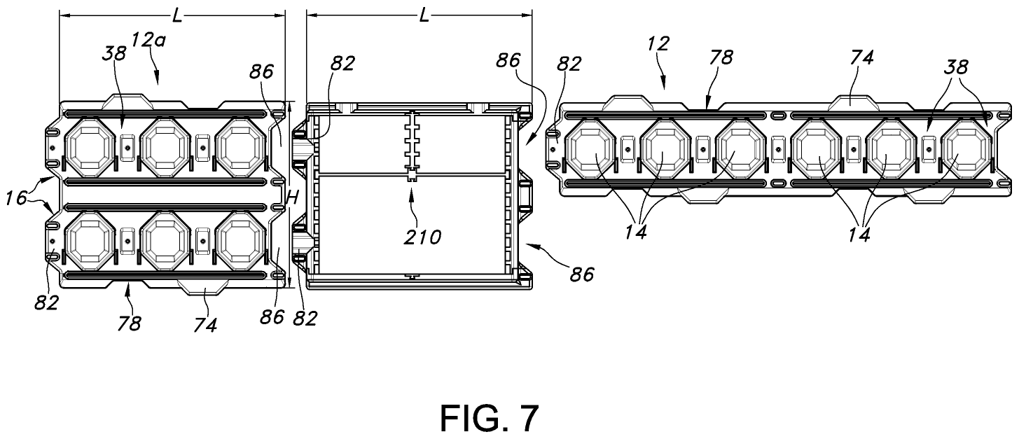

As illustrated in FIGS. 1 and 7, a multi-component storage system of the present invention may include a primary storage component 100 and one or more wall rails 12. A wall rail 12 may include a plurality of protrusions 14 (e.g., hanging structures, projections, cleats, and/or the like) repeated along a length of the wall rail 12, which may be engaged by a modular accessory to mount the modular accessory to the wall rail 12. As best shown in in FIGS. 1 and 7, the protrusions 14 may include octagonally-shaped structures with each protrusion 14 including a base portion 18 that extends from a surface 22 of the wall rail 12, a plurality of angled portions 26 (e.g., two upper angled sides, two lower angled sides, and/or the like), two or more vertical sides 28 joining upper and lower angled portions 26, and two or more substantially horizontal sides 30. The upper angled sides may each define a lip, a ledge, or an overhang portion 32 that extends outward from the base portion 18 and defines an undercut 34 between the overhang portion 32 and the surface 22 of the wall rail 12. As persons having skill in the art will appreciate, protrusions 14 may include any other suitable geometric shape (i.e., a different shape than an octagon) without deviating from the instant disclosure.

One or more mount interfaces may be disposed proximate to and/or adjacent to a single protrusion 14 or such mount interfaces may be disposed proximate to and/or between two adjacent protrusions 14. For example, in some embodiments, a mount interface is a first mount interface 38 (FIG. 1) disposed between edges or sides of two adjacent protrusions 14. Note that wall rail 12 may include a variety of differently sized and/or shaped mount interfaces formed thereon, including but not limited to those shown in broken/phantom lines in FIG. 1. Such mount interfaces may be in the form of regions, areas (e.g., planar areas), or portions of the wall rail 12 that are configured to interface with a modular accessory as described herein. That is, one or more modular accessories may mount or attach to the wall rail 12 at one or more mount interfaces, and occupy at least a portion of the area defined by such mount interfaces. In some embodiments, the first mount interface 38 may be substantially rectangular in shape for receiving and/or interfacing with an accessory interface (described below) having a predetermined profile that is configured to mount to, attach to, and/or otherwise interface with the first mount interface 38. Other sizes and/or shapes of mounting interfaces are contemplated (e.g., square shapes, polygonal shapes, rhombus shapes, symmetric shapes, asymmetric shapes, regular shapes, irregular shapes, and/or the like, may be formed and employed as mount interfaces on the wall rail 12). As FIG. 7 further illustrates, the first mount interface 38 may occupy a space proximate and adjacent to a single protrusion 14 and/or a space proximate to and between adjacent protrusions 14. Such spaces and, thus, such mount interfaces may be formed as a rectangular region 46A, an oval region 46B, and/or the like. As persons of skill in the art will appreciate, other sizes and shapes of the mount interfaces described herein may be defined over any given region(s) of the wall rail 12 for mounting a modular accessory thereto. That is, a modular accessory may be movable between the wall rail 12 and/or other storage components (e.g., a toolbox, a crate, and/or the like) as described herein. In this way, a user may create a customized organizational scheme for modular accessories (e.g., batteries, tools, blades, etc.) at various points or locations (e.g., on a wall rail, in a toolbox) of a storage system.

The wall rail 12 may additionally include alignment structures (e.g., horizontal alignment protrusions 74 alignable with horizontal alignment recesses 78, vertical alignment protrusions 82 alignable with vertical alignment recesses 86) to vertically and horizontal align a plurality of wall rail 12. The alignment structures (74 and 78) may form and/or define mount interfaces to which modular accessories may be mounted or attached.

In some aspects, a wall rail 12 may include a plurality of protrusions 14 repeated along both a length and a height of the wall rail 12. For instance, the wall rail may have a plurality of rows 16 of protrusions 14 extending along a length of the rail. In some aspects, the wall rail may be provided with vertical alignment protrusion 82 and a vertical alignment recess 86 along each respective row 16 of the wall rail 12.

FIG. 7 illustrates a wall rail 12a having a plurality of rows 16 of protrusions 14, for instance, arranged in an array. As shown in FIG. 7, the wall rail 12a may have two rows 16 of protrusions 14. Across the rows 16, the protrusions 14 may be arranged in vertical columns. The wall rail 12a may include three protrusions 14 along a length of the wall rail 12a. In this arrangement, the wall rail 12a may have approximately equivalent length L and height H dimensions as a wall-mountable open primary storage component 100d. In this manner, the wall-mountable primary storage component 100d can integrate seamlessly with wall rails 12, 12a in a multi-component storage assembly as illustrated in FIGS. 1 and 7 to provide static organization solutions for secondary storage components 200.

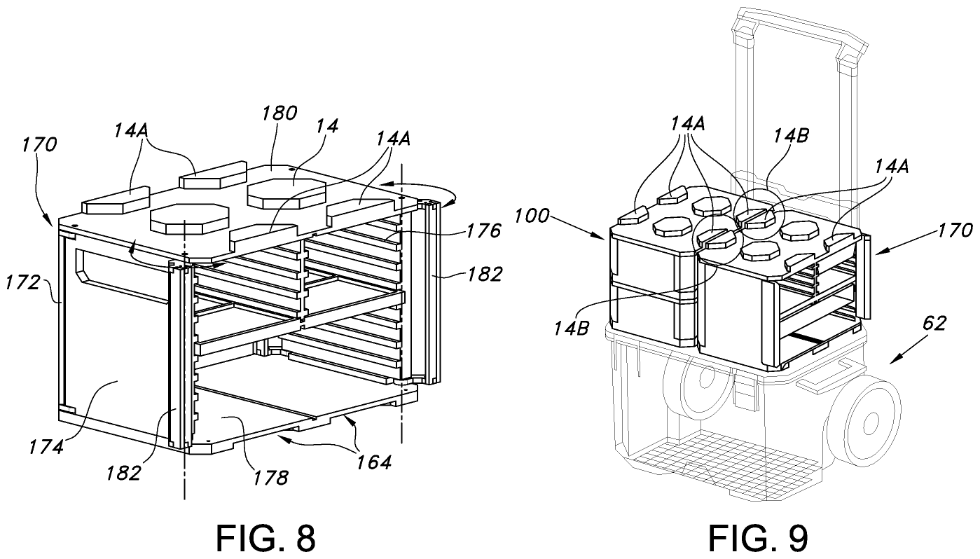

FIG. 8 illustrates a primary storage component 100 in the form of an open cabinet 170 similar to that described as primary storage component 100b above (see FIG. 2). The open cabinet 170 is formed from a body 172 having at least a first side 174, a second side 176, a bottom panel 178, and a top panel 180. The open cabinet 170 may optionally include a rear panel and/or a front panel (not shown). The first side 174, second side 176, and bottom panel 178 may be formed from a singular construction, e.g., by molding, or may be formed as separate panels or pieces and coupled together. A plurality of connectors 182 may be provided to couple the sides, bottom panel 178, top panel 180, and, if present, the rear and/or front panels, of the open cabinet 170. As shown in FIG. 8, each of the connectors 182 may form a respective corner of the open cabinet 170. The connectors 182 may have a length spanning a distance between the bottom panel 178 and the top panel 180. The connector 182 may be configured to form a swinging locking corner tab, e.g., to lock the sides, top panel 180, and bottom panel 178 in place while being able to swing or rotate to open or unlock the connector 182. For instance, the connectors 182 may be configured for ambidextrous installation. In other words, each connector 182 may form a swinging locking tab configured to swing in both right and left directions relative to its adjacent sides 174 or 176. In some embodiments, each of the connectors 182 may be identical to each other to enable interchangeable configuration and setup.

As shown in FIG. 8, the open cabinet 170 forms a slotted primary storage component similar to the primary storage component 100B described above.

Similarly to the primary storage component 100B (FIG. 2), the open cabinet 170 may have protrusions 14 extending upward from an outer-facing surface of the top panel 180 and recesses 164 formed in an external surface of the bottom pane 178. The protrusions 14 and recesses 164 enable the open cabinet 170 to be coupled, e.g., stacked, and locked in place relative to one or more additional primary storage components 100 in the manner described above. Further, as illustrated in FIG. 8, the top panel 180 may include one or more partial protrusions 14A which may take a partial form of the shape of a protrusion 14. For instance, the partial protrusions 14A may form one-half of a protrusion 14 as illustrated in FIGS. 8-9. As best illustrated in FIG. 9, two or more primary storage components 100 may be stacked or placed adjacent to each other in a manner aligning the partial protrusions 14A. In this arrangement, two partial protrusions 14A from different primary storage components 100 may take the shape of a full protrusion 14, shown in FIG. 9 encircled by 14B.

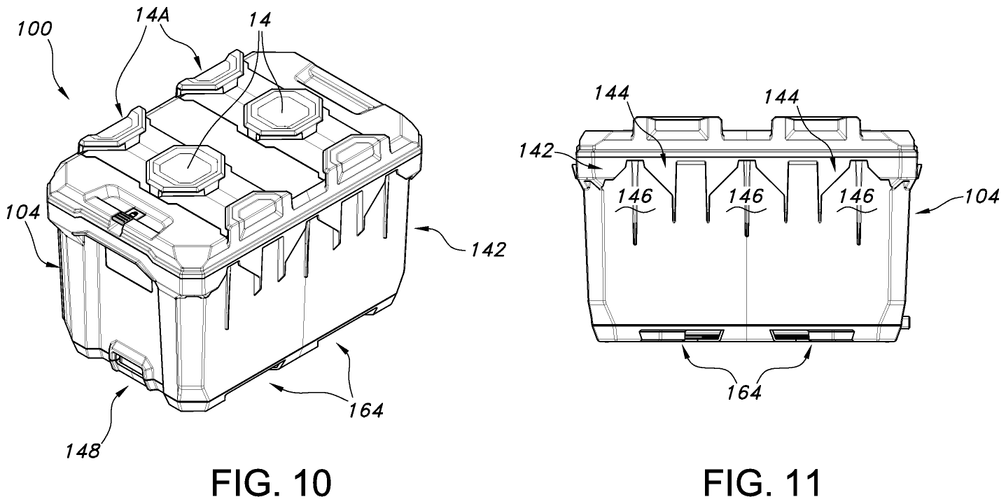

FIGS. 10-11 illustrate a primary storage component 100 having a mounting interface on a rear side, e.g., to engage with projections 14 such as on a storage rail 12. For instance, the body 102 may include a mounting interface 142 integrally formed therewith, e.g., by molding or other suitable manufacture. In this regard, a separate bracket 162 may not be necessary to engage the primary storage component 100 with a storage rail 12. FIGS. 10-11 illustrate the mounting interface 142 on a rear side of the primary storage component 100, i.e., opposite the open side 110 (not shown in FIGS. 10-11) so that, when the mounting interface is engaged with a storage rail 12 or other support surface 50, the open side 110 and storage area 104 is accessible to a user to remove or insert secondary storage components 200 from the storage area 104. The mounting interface 142 provides an advantageous

The mounting interface 142 may be complementary to the storage rail 12. For instance, the mounting interface 142 may include one or more integral brackets 144 having a complementary shape to a shape of the protrusions 14, e.g., such that a negative space 146 shape of the protrusions 14 may be formed between adjacent integral brackets 144. As best seen in FIG. 11, the integral brackets 144 may have a generally Y-shape to receive an upper portion of generally octagonal protrusions 14 therebetween.

FIGS. 10-13 further illustrate a primary storage component 100 configured for stacking (i.e., having protrusions 14 on a lid 132 and recesses 164 formed in a lower surface thereof, as illustrated in at least FIGS. 1 and 9 and described above). FIGS. 10-13 further illustrate a means of locking stacked primary storage components 100 in place. As shown in FIGS. 10, 12A-12B and 13, a latch 148 may be provided near the bottom of a primary storage component 100 and may engage with a spring-loaded locking member (not shown) configured to lock stacked storage components in place relative to each other. (Additional detail regarding the locking member are disclosed in U.S. patent application Ser. No. 17/153,251, filed Jan. 20, 2021, the entire contents of which is incorporated by reference herein). In accordance with the present invention, a locking piece 300 may additionally be provided with the primary storage component 100 to engage with the latch 148. By engaging the latch 148, the locking piece 300 may prevent the latch 148 from unlocking.

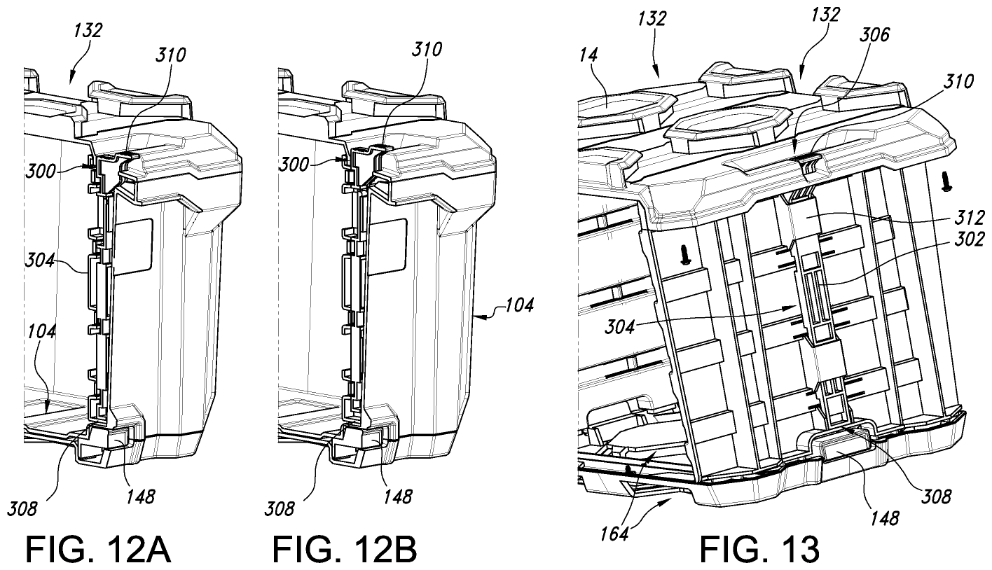

Turning to FIGS. 10 and 12A-B, the locking piece 300 may have a body 302 with an elongated portion 304 extending from an upper end 306 to a lower end 308 and a tab 310 extending from the upper end 306. The tab 310 may have a generally same or similar side profile or shape as a portion of a lid 132, as illustrated in FIGS. 12A-B. The locking piece 300 may extend through the lid 132 and the body 104. The body 104 may include one or more retaining features 312, e.g., slots (see FIG. 13), to hold the locking piece 300 in place. For instance, the slots 312 enable the locking piece 300 to translate along an axis relative to the body 104, e.g., a vertical axis, while preventing the locking piece 300 from moving in other directions. In some embodiments, one or more sides of the body 104 may be double-walled (as illustrated in FIGS. 12A-B and 13); however, the locking piece 300 is not required to be enclosed in a double-walled body 104.

FIG. 12A illustrates the locking piece 300 in an engaged (locked) position, and FIG. 12B illustrates the locking piece 300 in a disengaged (unlocked) position. In the engaged position, the locking piece 300 is inserted or depressed toward the lid 132 and the body 104 of the primary storage component 100, e.g., so the tab 310 aligns with a portion of the lid 132, e.g., in a coplanar manner. In the disengaged position, the tab 310 is raised upward relative to the lid 132 and does not align with a portion of the lid 132 in a coplanar manner. The locking piece 300 may translate along an axis between the engaged position and the disengaged position, e.g., up and down along a vertical axis. The axis may be generally parallel to a stacking direction (e.g., a direction in which primary storage components 100 are stacked together, as illustrated in FIGS. 1, 9).

In the engaged position of the locking piece 300 illustrated in FIG. 12A and 13, the lower end 308 may abut against or engage with a latch 148 to prevent the latch 148 from being engaged or activated in an upward direction. Because the latch 148 is otherwise configured to activate to slide the locking mechanism out of the way to enable separation of stacked components when the latch 148 is lifted, engagement of the lower end 308 of the locking piece 300 with the latch 148 prevents the latch 148 from being activated to separate the stacked components, effectively locking the components in the stacked arrangement. To ‘unlock’ the components from each other, the locking piece 300 may be transitioned into the disengaged position, releasing the contact or engagement between the lower end 308 and the latch 148. For instance, the locking piece 300 may be disengaged manually by a user raising or lifting the tab 310 in a direction away from the body 104 and the latch 148.

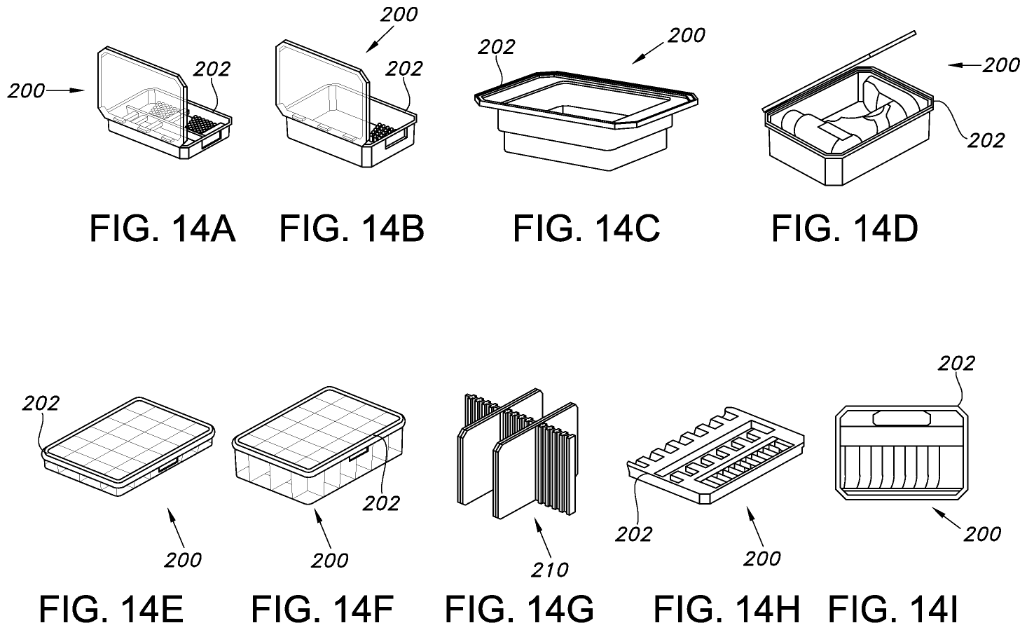

FIGS. 14A-I illustrate a non-exclusive variety of exemplary secondary storage components 200 configured to interface with a primary storage component 100 in the slotted storage system 10. For instance, the secondary storage components 200 may include but are not limited to various sizes of closed or lidded container, open containers or trays, generally planar panels, or the like, such as: accessory cases, e.g., storage case having a removable lid, as illustrated in FIGS. 14A-14B; trays/bin, e.g., open containers without a lid, as illustrated in FIG. 13C; tool specific enclosures, such as a drill enclosure illustrated in FIG. 14D; various sizes of small parts organizers, e.g., divided organized containers with or without a lid and in various depths, as illustrated in FIGS. 14E-14F; storage components such as trays configured to receive hand tools and other accessories in an open manner, such as the cable holder illustrated in FIG. 14H and the tool holding tray illustrated in FIG. 141; open or closed storage of batteries such as batteries configured to supply tools with power; and other storage items such as an insulated cooler for thermal controlled storage. Each secondary storage component 200 may include at least one insertion component, also referred to as a “wing” or a “flange”, as described previously which is configured to interface with the support ribs 120 and/or 212 to be supported within a primary storage component. Moreover, while not illustrated, one or more locking features may be provided to the primary storage component 100 and/or secondary storage component 200 to secure the secondary storage component 200. For instance, the one or more locking features may be provided to the support ribs 120, 212 and/or the “wings” of the secondary storage component 200.

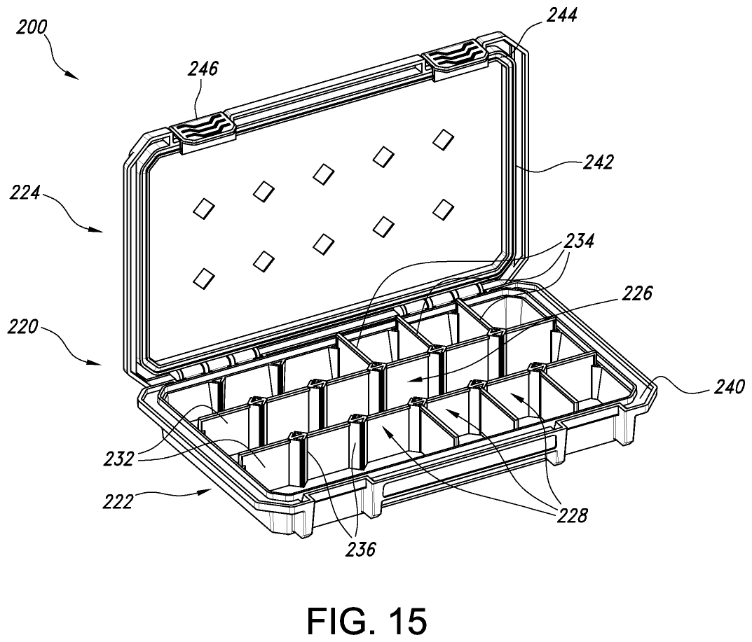

FIG. 15 illustrates a secondary storage component 200 in the form of a small parts organizer 220. The small parts organizer 220 comprises a body 222 and a lid 224 configured to enclose a storage volume 226 of the body 222. Within the storage volume 226, the body 222 may include one or more dividers 228 configured to divide the storage volume 226 into two or more small parts compartments 230. For instance, there may be one or more first direction dividers 232 extending along a first direction of the body 222, and/or one or more second direction dividers 234 extending along a second direction of the body 222. The first direction dividers 232 and the second direction dividers 234 may be removably coupled with the body 222. In this manner, the storage volume 226 and the small parts compartments 230 may be configurable and/or customizable based on a user's storage needs and/or preferences. The body 222 may have one or more receiving slots 236 configured to receive the first direction dividers 232 and/or the second direction dividers 234 therein.

As described above regarding FIGS. 14A-141, the small parts organizer 220 includes an insertion flange 202 extending around its perimeter and configure to be complementary with the support ribs 120 of a primary storage component 100. As illustrated in FIG. 15, the body 222 may include a body flange 240 extending around a perimeter of the body 222, such as around a perimeter of an opening of the body 222 to the storage volume 226. The lid 224 may include a lid flange 242 extending around a perimeter of the lid 224 and configured to contact or mate with the body flange 240 when the lid 224 is closed. In some embodiments, a seal 244 such as an O-ring seal may be provided to seal between the lid 224 and the body 222. One or more locking features 246 such as latches may be provided to secure or lock the lid 224 to the body 222.

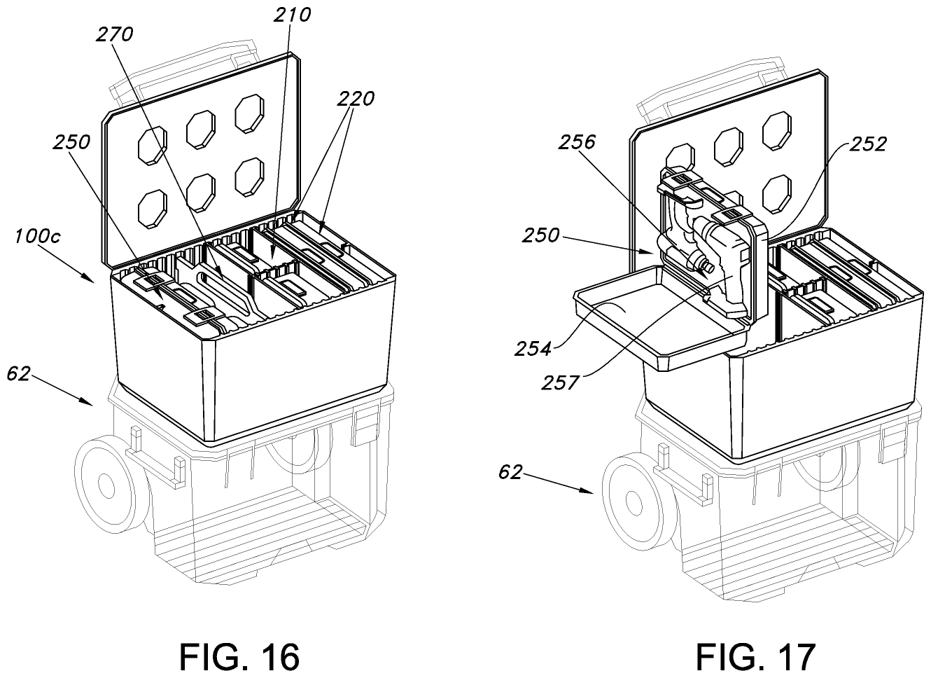

As illustrated in FIGS. 14A-141, the storage system of the present invention may further include a variety of secondary storage components 200 having similar arrangements as the small parts organizer 220 with regard to the insertion flange 202 and ability to couple with a primary storage component 100 having ribs 120 and slots 124 formed therebetween, i.e., a slotted storage system, as described above. FIGS. 16-21 illustrate in further detail additional non-limiting aspects of the secondary storage components 200 of the present invention.

FIGS. 16-21 each illustrate a storage tote 100c (a primary storage component) having a plurality of secondary storage components 200 stored therein. The secondary storage components 200 are each engaged with the ribs 120 within the storage tote 100c to hold each respective secondary storage component 200 in place within the storage tote 100c. Each storage tote 100c further includes dividers 210 further dividing the storage space within the storage tote 100c into multiple compartments.

FIGS. 16-17 illustrate, in part, a tool case 250, i.e., a lidded or enclosed container. The tool case 250 may have a similar construction to the small parts organizer 220 described in detail above, e.g., having a body 252, a lid 254, a storage volume 256. An insertion flange 202 surrounds a periphery of the tool case 250 and is configured to engage with the ribs 120 of the storage tote 100c. In some aspects, the storage volume 256 may include a support 257 fitted therein, the support having one or more cavities fitted to an outer shape of a respective tool for storing within the tool case 250. For instance, the support 257 may be formed of foam or other soft, flexible material configured to support a tool within the storage volume 256 while maintaining its shape.

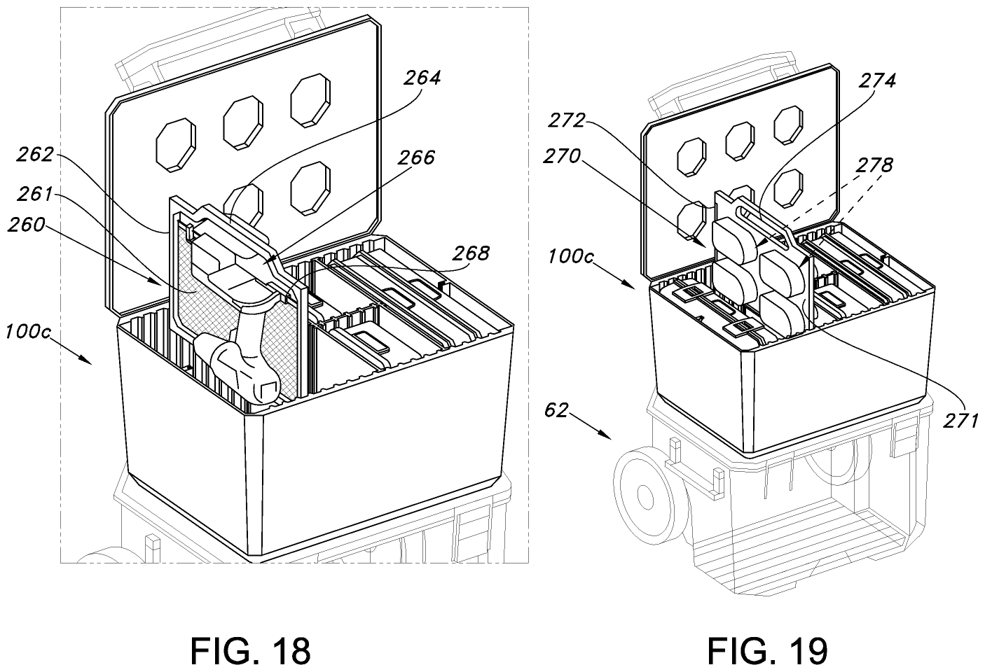

FIG. 18 illustrates a slot panel 260 configured to be inserted into the storage space of the storage tote 100c and engaged with the ribs 120. The slot panel 260 may have a panel body 261, a peripheral flange 262 surrounding the panel body 261 and configured for engagement with the ribs 120, and a grip portion 264 configured for a user to grip and pull the slot panel 260 out of the storage tote 100c. The grip portion 264 may be spaced apart from the panel body 261 by an opening 266. The panel body 261 may be configured to receive one or more clips 268 thereon, e.g., to store a tool. For instance, as illustrated in FIG. 18, a tool may include a plurality of clips 268 (e.g., belt clips) which may slide onto the panel body 261 along an edge 263 of the panel body 261 bordering the opening 266. The tool may be further stabilized by positioning a portion of the tool within the opening 266 and abutting against the grip portion 264.

FIGS. 16 and 19 illustrate a battery holder panel 270. The battery holder panel 270 may be configured to be inserted into the storage space of the storage tote 100c and engaged with the ribs 120. The battery holder panel 270 may have a panel body 271, a peripheral flange 272 surrounding the panel body 271 and configured for engagement with the ribs 120, and a grip portion 274 or handle configured for a user to grip and pull the battery holder panel 270 out of the storage tote 100c. The grip portion 274 may be spaced apart from the panel body 271 by an opening 276 to provide ease of handling for a user to grip the grip portion 274. The panel body 271 may include one or more openings 278 configured to receive a portion of a battery therethrough. For instance, FIG. 19 illustrates a battery holder panel 270 configured to store or hold four batteries, i.e., having four openings 278 that receive a portion of a battery therethrough.

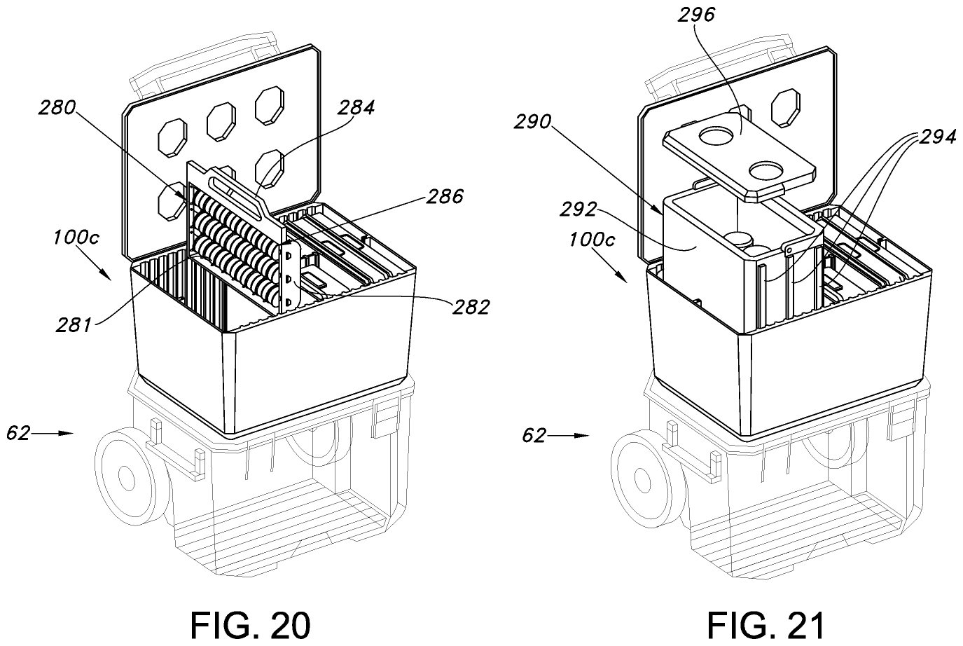

FIG. 20 illustrates a cable or wire storage panel 280. The wire storage panel 280 has similar construction to the tool slot panel 260 and the battery holder panel 270 in its configuration to engage with the ribs 120 of a primary storage component 100. The wire storage panel 280 further includes one or more rows of spool storage 286 formed in a wire storage panel body 281 and surrounded by a wire storage panel flange 282. A grip portion 284 or handle may be provided for ease of insertion and removal.

FIG. 21 illustrates another alternative secondary storage component 200 configured to store items within a storage space, e.g., a lidded container. In particular, FIG. 20 illustrates a cooler 290 (e.g., a thermal insulating cooler such as those typically used to store cold beverages or perishable food items) having a cooler body 292 configured for insertion within a primary storage component such as a storage tote 100c. The cooler body 292 may include ribs 294 extending or protruding from parallel outer surfaces thereof and configured for engagement with the ribs 120 of the storage tote 100c. A lid 296 may further be provided to enclose the cooler 290. The cooler 290 may be, for instance, formed of a blow-molded construction having the ribs 294 integrally formed with the body 292, or formed from any other suitable construction. The present inventors have found that providing a cooler 290 as a secondary storage component 200 configured to integrate with the storage system of the present invention may improve job site storage, organization, and user satisfaction.

Further aspects of the invention are provided by one or more of the following embodiments:

A storage system includes a primary storage component and a secondary storage component. The primary storage component includes a body surrounding a storage area, the body having a plurality of support ribs extending therefrom, the plurality of support ribs including at least one pair of support ribs on opposing sides of the body. The primary storage component includes at least one open side. The secondary storage component is configured to be inserted within the storage area of the primary storage component through the at least one open side and aligned with the at least one pair of support ribs.

The storage system of any one or more of the embodiments, wherein the body comprises a base, a lid, at least two sides extending between the base and the lid, and a connector configured to couple adjacent sides of the body to each other, to the base, and to the lid.

The storage system of any one or more of the embodiments, wherein each connector is identical and configured for ambidextrous installation.

The storage system of any one or more of the embodiments, wherein each connector extends from the base to the lid.

The storage system of any one or more of the embodiments, wherein each connector forms a swinging locking tab configured to lock adjacent sides of the body to each other.

The storage system of any one or more of the embodiments, further comprising at least one divider inserted within the storage area and aligned with one or more ribs of the plurality of support ribs, the divider comprising a plurality of ribs on an outer surface thereof and a plurality of ribs on an inner surface thereof.

The storage system of any one or more of the embodiments, wherein the at least one divider is configured to divide the storage area in a first direction.

The storage system of any one or more of the embodiments, wherein the at least one divider comprises a second divider configured to divide the storage area in a second direction different from the first direction.

The storage system of any one or more of the embodiments, wherein the second direction is perpendicular to the first direction.

The storage system of any one or more of the embodiments, wherein the body of the primary storage component comprises at least one mounting interface configured to mount the body to a support surface, the at least one mounting interface extending from an outer surface of the body.

The storage system of any one or more of the embodiments, wherein the at least one mounting interface comprises at least two mounting interfaces, wherein a first mounting interface and a second mounting interface of the at least two mounting interfaces extend from different sides of the body.

The storage system of any one or more of the embodiments, further comprising at least one alignment protrusion extending from a side of the body and configured to align the primary storage component with one or more wall rails.

The storage system of any one or more of the embodiments, further comprising at least one alignment recess along a side of the body configured to align the primary storage component with an alignment protrusion of one or more wall rails.

The storage system of any one or more of the embodiments, the body comprising at least one side comprising a plurality of cleats on an outer surface extending in a direction away from the storage area, the cleats being configured to couple with a complementary bracket.

The storage system of any one or more of the embodiments, the body comprising at least one side comprising a plurality of recesses on an outer surface extending in a direction towards the storage area, the recesses being configured to receive a complementary cleat.

The storage system of any one or more of the embodiments, wherein the plurality of recesses each extend in a direction in a direction parallel to a stacking direction of the primary storage component.

The storage system of any one or more of the embodiments, wherein the secondary storage component comprises an insertion flange configured to be engaged with the at least one pair of support ribs, the secondary storage component selected from the group consisting of: a lidded container, a panel configured for coupling an item to be stored, an open-sided tray.

The storage system of any one or more of the embodiments, further comprising a storage rail configured to be mounted to a vertical support surface, the storage rail comprising a plurality of cleats, an alignment protrusion on one side of the storage rail and an alignment recess on an opposite side of the storage rail.

The storage system of any one or more of the embodiments, wherein the plurality of cleats are arranged in an array including at least two rows and at least two columns of cleats.

The storage system of any one or more of the embodiments, wherein the primary storage component and the storage rail each have a length in a longitudinal direction that is approximately equal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A storage system comprising:
a primary storage component having a body surrounding a storage area, the primary storage component having at least one open side, the body having a plurality of support ribs extending therefrom, the plurality of support ribs including at least one pair of support ribs on opposing sides of the body; and
a secondary storage component configured to be inserted within the storage area of the primary storage component through the at least one open side and aligned with the at least one pair of support ribs.

2. The storage system of claim 1, wherein the body comprises a base, a lid, at least two sides extending between the base and the lid, and a connector configured to couple adjacent sides of the body to each other, to the base, and to the lid.

3. The storage system of claim 2, wherein each connector is identical and configured for ambidextrous installation.

4. The storage system of claim 2, wherein each connector extends from the base to the lid.

5. The storage system of claim 2, wherein each connector forms a swinging locking tab configured to lock adjacent sides of the body to each other.

6. The storage system of claim 1, further comprising at least one divider inserted within the storage area and aligned with one or more ribs of the plurality of support ribs, the divider comprising a plurality of ribs on an outer surface thereof and a plurality of ribs on an inner surface thereof.

7. The storage system of claim 6, wherein the at least one divider is configured to divide the storage area in a first direction.

8. The storage system of claim 7, wherein the at least one divider comprises a second divider configured to divide the storage area in a second direction different from the first direction.

9. The storage system of claim 8, wherein the second direction is perpendicular to the first direction.

10. The storage system of claim 1, wherein the body of the primary storage component comprises at least one mounting interface configured to mount the body to a support surface, the at least one mounting interface extending from an outer surface of the body.

11. The storage system of claim 10, wherein the at least one mounting interface comprises at least two mounting interfaces, wherein a first mounting interface and a second mounting interface of the at least two mounting interfaces extend from different sides of the body.

12. The storage system of claim 1, further comprising at least one alignment protrusion extending from a side of the body and configured to align the primary storage component with one or more wall rails.

13. The storage system of claim 1, further comprising at least one alignment recess along a side of the body configured to align the primary storage component with an alignment protrusion of one or more wall rails.

14. The storage system of claim 1, the body comprising at least one side comprising a plurality of cleats on an outer surface extending in a direction away from the storage area, the cleats being configured to couple with a complementary bracket.

15. The storage system of claim 1, the body comprising at least one side comprising a plurality of recesses on an outer surface extending in a direction towards the storage area, the recesses being configured to receive a complementary cleat.

16. The storage system of claim 15, wherein the plurality of recesses each extend in a direction in a direction parallel to a stacking direction of the primary storage component.

17. The storage system of claim 1, wherein the secondary storage component comprises an insertion flange configured to be engaged with the at least one pair of support ribs, the secondary storage component selected from the group consisting of: a lidded container, a panel configured for coupling an item to be stored, an open-sided tray.

18. The storage system of claim 1, further comprising a storage rail configured to be mounted to a vertical support surface, the storage rail comprising a plurality of cleats, an alignment protrusion on one side of the storage rail and an alignment recess on an opposite side of the storage rail.

19. The storage system of claim 18, wherein the plurality of cleats are arranged in an array including at least two rows and at least two columns of cleats.

20. The storage system of claim 18, wherein the primary storage component and the storage rail each have a length in a longitudinal direction that is approximately equal.
